(19) United States
(12) Patent Application Publication
(10) Pub. No.: US 2013/0056938 A1
(43) Pub. Date: Mar. 7, 2013

(54) SEAL MEMBER FOR FLUID TRANSFER SYSTEMS

(71) Applicants: Carl Romack, Annarbor, MI (US); Dale Moretz, Jackson, MI (US)

(72) Inventors: Carl Romack, Annarbor, MI (US); Dale Moretz, Jackson, MI (US)

(21) Appl. No.: 13/665,770

(22) Filed: Oct. 31, 2012

Related U.S. Application Data
(63) Continuation-in-part of application No. 13/147,458, filed on May 17, 2012.
(60) Provisional application No. 61/149,256, filed on Feb. 2, 2009.

(51) Int. Cl. F16K 5/08

(52) U.S. Cl. 277/627

(57) ABSTRACT

A seal assembly for selectively completing a fluid passageway defined between an upstream member and a downstream member separated by an intermediate space. The seal assembly, which is movably positionable in an opening defined through the upstream member between opposite first and second surfaces thereof, comprises: a resiliently deformable, radially-extending flange provided at a first end of the seal assembly; a sealing face provided at an opposite, second end of the seal assembly; and a fluid passageway extending through the seal assembly between the flange and the sealing face. The flange is deformable under fluid pressure to increase the area of contact between the flange and the first surface of the upstream member, and to simultaneously move the seal assembly within the opening defined in the upstream member so as to bring the sealing face into sealing contact with an opposing surface of the downstream member across the intermediate space. The seal assembly is comprised of at least two axially mating portions, one of the at least two axially mating portions comprising the flange and the other of the at least two axially mating portions comprising the sealing face.

### CROSS-REFERENCE TO RELATED APPLICATIONS

This application is a continuation-in-part application claiming the benefit of priority from, United patent application Ser. No. 13/147,458 which is a 35 U.S.C.§371 national stage filing of International Patent Application No. PCT/US2010/022863, filed Feb. 2, 2010, and through which priority is claimed to U.S. Provisional Patent Application No. 61/149,256, filed Feb. 2, 2009, the disclosures of which are incorporated herein by reference in their entireties.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### FIELD OF THE INVENTION

The present invention relates to the field of fluid transfer systems wherein a fluid is selectively transferred through a fluid passageway defined between an upstream member and a downstream member which are separated by an intermediate space, and more particularly to a seal member for such fluid transfer systems that is deformable under fluid pressure to selectively create sealing contact between the seal member and an opposing surface of the downstream member across the intermediate space.

### BACKGROUND OF THE INVENTION

Fluid transfer systems—wherein a fluid is selectively transferred through a fluid passageway defined between an upstream member and a downstream member separated by an intermediate space—are known in a myriad of forms. In such systems, sealing means are employed to seal separate, but related, upstream and downstream components that cannot easily be permanently fused together, or which components otherwise need to be capable of engagement and disengagement and/or which are required to selectively move independently of each other. Such sealing means conventionally take a myriad of forms, including, without limitation, gaskets, O-rings, quad seals, sealing beads, lip seals, etc.

Unfortunately, sealing means of such conventional construction as the aforementioned are attended by a number of drawbacks. First, these sealing means generally require the maintenance of very consistent interface dimensions between the upstream and downstream components being sealed thereby, as conventional sealing means typically possess a limited capacity to compensate for variations in dimensional separation or geometric differences between the components. Even in the case of relatively dynamic sealing means, such as O-rings, quad seals, and lip seals, if there is even a relatively small change in either the distance between the upstream and downstream components or the geometric relationship therebetween, the sealing capacity of these conventional sealing means is compromised and the fluid seal may be lost.

It would thus be advantageous to have a seal member for a fluid transfer system which is capable of compensating for changes in either or both of the upstream and downstream components between which the seal is being established, and/or to compensate for changes in the dimensional or geometric relationships between the components.

### SUMMARY OF THE DISCLOSURE

The present invention encompasses improvements to the prior art by providing a seal assembly for selectively completing a fluid passageway defined between an upstream member and a downstream member separated by an intermediate space. The seal assembly, which is movably positionable in an opening defined through the upstream member between opposite first and second surfaces thereof, comprises: a resiliently deformable, radially-extending flange provided at a first end of the seal assembly; a sealing face provided at an opposite, second end of the seal assembly; and a fluid passageway extending through the seal assembly between the flange and the sealing face. The flange is deformable under fluid pressure to increase the area of contact between the flange and the first surface of the upstream member, and to simultaneously move the seal assembly within the opening defined in the upstream member so as to bring the sealing face into sealing contact with an opposing surface of the downstream member across the intermediate space. The seal assembly is comprised of at least two axially mating portions, one of the at least two axially mating portions comprising the flange and the other of the at least two axially mating portions comprising the sealing face.

Per another embodiment, providing for a sealing surface larger than the opening through the upstream member (and therefore the possibility of greater counter pressure allowing the balance of pressures to achieve optimum sealing and low friction at the interface of the seal face and the downstream member), at least two axially mateable portions comprise a seal member including the resiliently deformable, radially-extending flange, and a cover member including the sealing face. At least one of the seal member and the cover member include a stem portion defining at least a portion of the fluid passageway through the seal assembly, the stem portion axially mating with the other of the seal member or the cover member.

Per another feature, the seal member includes an elongate stem portion, and the cover member includes a cover stem portion defining an interior bore sized to at least partially receive therein the elongate stem portion. Further, the cover member includes an opening through the sealing face in fluid communication with the interior bore, the opening through the sealing face defining a portion of the fluid passageway.

In one aspect, the exterior surface of the elongate stem portion of the seal member is complimentary in shape to the shape of the interior bore of the cover member.

In another aspect, the elongate stem portion of the seal member terminates at an annular face that abuts an opposing annular shelf defining the bottom of the interior bore of the cover member.

Per a still further aspect, the interior surface of the cover member defines an annular stop formed at a spaced apart distance from the sealing face and the exterior surface of the seal member defines a second annular stop spaced away from the interior shelf. The annular stops rest against one another when the cover member is mounted on the seal member.

According to yet another feature, the elongate stem portion of the seal member includes a locking feature that engages a corresponding locking feature formed on the cover member. Per this aspect of the present invention, the locking feature of one of the cover member and stem portion may comprise a protruding boss, and the locking feature of the other of the cover member and the elongate stem portion of the seal member may comprise an indentation sized to receive the protruding boss therein.

In still another aspect, one of the elongate stem portion of the seal member and the cover member further includes a locating feature sized to engage a complimentary surface formed on the other of the cover member or the elongate stem portion of the seal member. The locating feature and complementary surface are arranged so that, when engaged, the axially mating portions of the seal assembly are mated in a predefined radial orientation relative to each other.

Per a still further feature, the sealing face is provided with one or more grooves dimensioned to permit a fluid to enter a sealing interface defined between the sealing face and an opposing surface of the downstream member. The one or more grooves may, in one aspect of the invention, comprise a plurality of discrete grooves partially surrounding the opening through the cover member, or a continuous circular groove surrounding the opening through the cover member.

Per another feature, the sealing face is further provided with one or more feed channels for communicating a fluid from the fluid passageway to one or more of the one or more grooves.

According to a further feature, the radially-extending flange is an annular flange of convex cross-section extending radially away from a central axis of the seal assembly defined coaxially with a longitudinal axis of the fluid passageway. The radially-extending flange may be further characterized by a tapered thickness proceeding radially outwardly from the said central axis to a peripheral edge of the flange.

### BRIEF DESCRIPTION OF THE DRAWINGS

For a better understanding of the present invention and to show more clearly how it may be carried into effect, reference will now be made, by way of example, to the accompanying drawings, which show an exemplary embodiment of the present invention, and in which:

FIG. 1a is a quartering perspective view of a portion of an exemplary operational environment for the present inventive seal member, comprising a rotary valve for a vehicle automatic transmission system;

FIG. 1b is a cross-sectional view of FIG. 1a;

FIG. 2 is a perspective view of one embodiment of the inventive seal member;

FIG. 3 is a cross-sectional view of the seal member of FIG. 2;

FIG. 4 is a perspective view of a seal member according to a second embodiment;

FIG. 5 is a bottom plan view of the seal member of FIG. 4, the flange having been removed from view;

FIG. 6 is a cross-sectional view of the seal member of FIGS. 4 and 5;

FIG. 7 is a perspective view of a seal member according to a third embodiment;

FIG. 8 is a bottom plan view of the seal member of FIG. 7, the flange having been removed from view;

FIG. 9 is a cross-sectional view of the seal member of FIGS. 7 and 8;

FIG. 10 is a cross-section view of a seal member according to a fourth embodiment;

FIG. 11 is a cross-sectional view showing the seal member in an exemplary operational environment, and according to which the seal member is shown with the flange thereof in the default, un-deformed condition;

FIG. 12 depicts the seal member of FIG. 11 with the flange thereof in the deformed condition;

FIG. 13 is a graph depicting, in the form of a representative curve derived from experimental data, the relationship between the relative (as a percentage) fluid pressure acting on the seal member and the relative deflection (also as a percentage) of the seal member;

FIG. 14 depicts in perspective a seal member according to a further embodiment;

FIG. 15 is a perspective view of a downstream, inner member comprising part of an exemplary rotary valve in which the seal member of the present invention may be employed;

FIG. 16 is a perspective view of an upstream, outer member comprising part of an exemplary rotary valve in which the seal member of the present invention may be employed;

FIG. 17 is a perspective, cross-sectional view of an exemplary rotary valve comprising the inner and outer members of FIGS. 15 and 16, and the seal member of FIG. 14; and

FIG. 18 is a cross-sectional elevation of the exemplary rotary valve of FIG. 17.

FIG. 19 is a perspective view of a seal assembly according to an alternative embodiment, the seal assembly being shown in an exemplary operational environment;

FIG. 20 is a cross-sectional view of the apparatus of FIG. 19;

FIG. 21 is a perspective view of the sectional portion of the apparatus of FIG. 20;

FIG. 22 is a perspective view of the seal assembly of FIG. 19;

FIG. 23 is a cross-sectional view of the seal assembly of FIG. 22;

FIG. 24 is a cross-sectional view of an alternative embodiment of the seal assembly having a locking feature;

FIG. 25 is a cross-sectional view of an exemplary seal member for an alternative embodiment of the seal assembly having a locating feature;

FIGS. 26a and 26b comprise, respectively, front face and perspective views of an exemplary cover member for an embodiment of the seal assembly, according to FIGS. 19-23, having discrete, semi-circular lubricating grooves.

FIGS. 27a and 27b comprise, respectively, front face and perspective views of an exemplary cover member for an alternative embodiment of the seal assembly having lubricating grooves which each define a continuous circle.

FIG. 28a is a front face view of an exemplary cover member for an alternative embodiment of the seal assembly, wherein the sealing face of the cover member is characterized by a generally ovoid shape.

FIG. 28b is a lateral view of the cover member of FIG. 28a.

FIG. 28c is an end view of the cover member of FIG. 28a.

FIG. 28d is a top-down perspective view of the cover member of FIG. 28a.

FIG. 28e is a bottom-up perspective view of the cover member of FIG. 28a.

FIG. 29a is a perspective view of the front face of an exemplary cover member for an alternative embodiment of the seal assembly, wherein a number of the lubricating grooves provided in the face are in communication with the fluid passage via feed channels.

FIG. 29b is a perspective view of the front face of an exemplary cover member for another alternative embodiment of the seal assembly, wherein all of the lubricating grooves provided in the face are in communication with the fluid passage via feed channels.

### WRITTEN DESCRIPTION

As required, detailed embodiments of the present invention are disclosed herein. However, it is to be understood that the disclosed embodiments are merely exemplary of the invention, which may be embodied in various and alternative forms. The accompanying drawings are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the present invention.

Referring now to the drawings, the present invention is generally characterized as a seal member for selectively completing a fluid passageway defined between an upstream member and a downstream member separated by an intermediate space, such as, by way of non-limiting example, as embodied in a rotary valve of the type disclosed in United States published application 2007/0107787, the disclosure of which is incorporated herein by reference in its entirety.

As disclosed in United States published application 2007/0107787, such a rotary valve comprises a downstream member in the form of a housing having an interior cavity, and an upstream member in the form of an inner member moveably disposed within the interior cavity of the downstream housing and separated therefrom by an intermediate space. The upstream, inner member has an interior cavity for holding a fluid, such as, for instance, hydraulic fluid for an automatic transmission system. At least one inlet passageway is defined through each of the downstream housing and the upstream, inner member, respectively, for communicating a fluid to the interior cavity of the inner member. Further, at least one outlet opening is provided through the wall of the upstream, inner member, to thus permit fluid communication from the interior cavity to the exterior of the inner member. Preferably, a plurality of such outlet openings are provided, each extending radially relative to the longitudinal axis of the inner member so as to terminate in about the circumference of the exterior surface of the inner member. Each of the outlet openings is arranged so that incremental rotational movement of the inner member will selectively bring at least one opening into communication with one of a plurality of passageways defined through the downstream housing.

As noted, either the upstream inner member or the downstream outer member is selectively moveable relative to the other, and incremental rotational movement of the upstream or downstream member relative to the other may be accomplished by such exemplary motors as a stepper motor, variable solenoid, or servomotor, etc. By operation of the motor in response to a controller, the one member is selectively rotatably moved relative to the other by an angular distance which brings a desired one or more of the outlet openings into radial alignment with one or more of the plurality of passageways defined through the housing, thereby permitting communication of a fluid from the interior cavity of the inner member through the housing (and thence, for instance, through an opening in a manifold to a selected one of the clutch activators) via the radially aligned passageways/openings.

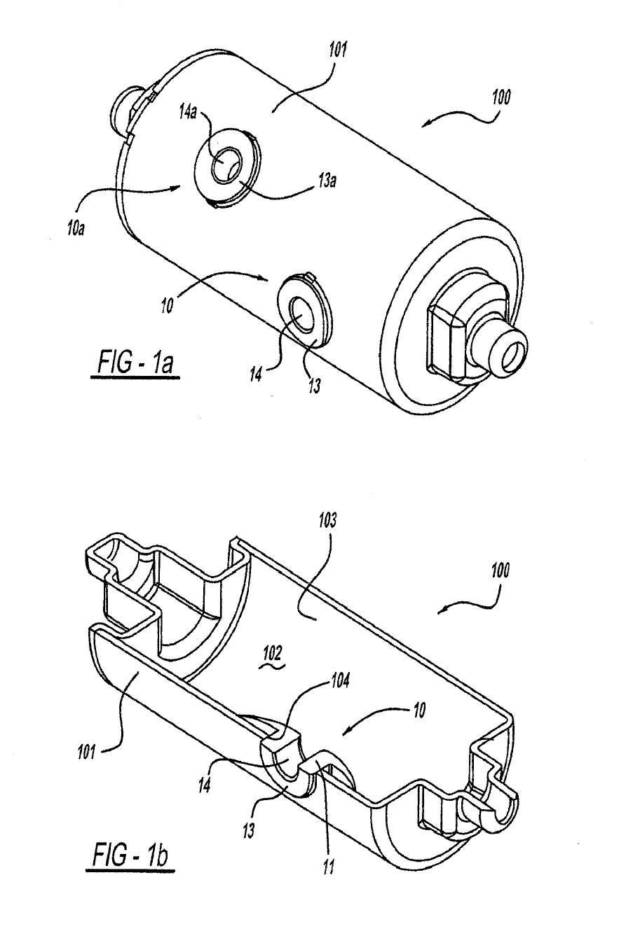

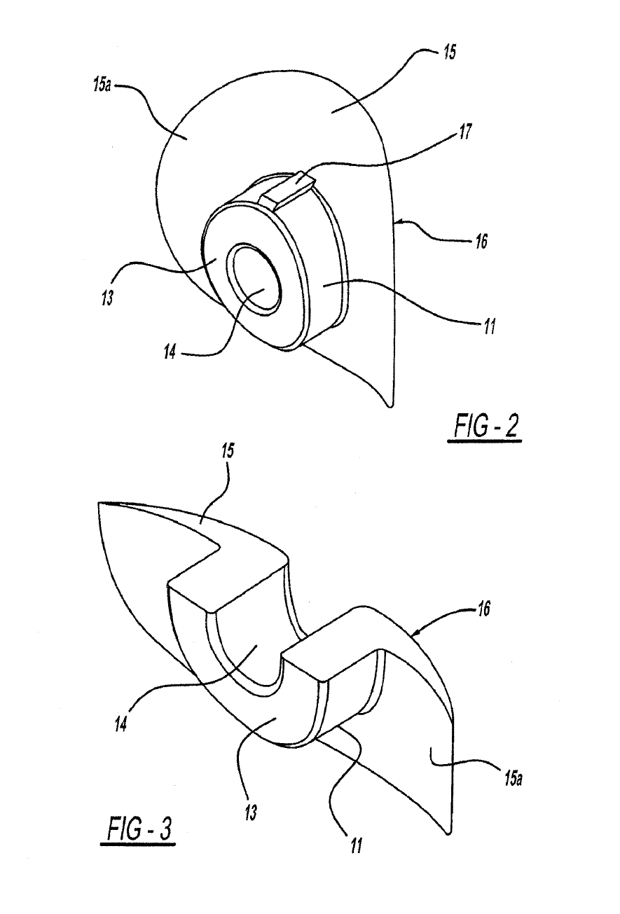

With reference now being had to FIGS. 1a and 1b, wherein the seal members 10, 10a are shown in an exemplary operational environment comprising a rotary valve for a vehicle automatic transmission system such as heretofore described—in which the illustrated upstream member for the fluid transfer system is in the form of an inner member 100 having an exterior surface 101, an interior cavity 102 defined by an interior surface 103, and at least one outlet opening 104 defined therethrough—and also to FIGS. 2 and 3, each seal member 10 (shown in cross-section in FIGS. 1b and 2) may be seen to basically comprise an elongate stem portion 11 dimensioned to be movably positionable in the outlet opening 104, a resiliently-deformable flange 15 provided at one end of the stem portion 11, a sealing face 13 provided at the opposite end of the stem portion 11, and a fluid passageway 14 defined through the stem portion between the flange and the sealing face.

The flange 15 is deformable under fluid pressure created in the upstream member in order to increase the area of contact between the flange 15 and the interior surface of the upstream member (per the illustrated embodiment, the interior surface 103 of the inner member 100) and to simultaneously move the stem portion 11 within the outlet opening (104 in the embodiment of FIGS. 1a and 1b) defined in the upstream member so as to bring the sealing face 13 into sealing contact with an opposing surface of the downstream member across the intermediate space defined therebetween (not depicted in FIGS. 1a through 3). In accomplishment of the foregoing, the flange 15 is, according to the illustrated embodiment, configured as an annular flange 15 of convex cross-section (as viewed from the top down where the flange 15 defines the top of the seal member 10 and the sealing face 13 defining the bottom) extending radially from a central axis of the seal member 10 defined coaxially with the longitudinal axis of the passageway 14. Referring particularly to FIGS. 2 and 3, flange 15 is further characterized by a tapered thickness proceeding radially outwardly from the said central axis to the flange peripheral edge 15a. The taper of the flange 15 is such that, according to the material from which the seal member 10 is manufactured and the pressure of a fluid acting on the upper surface 16 of the flange 15, such fluid pressure will cause deformation of the flange 15 in the manner described in more detail herein below. Of course, it will be appreciated that flange 15 may take any shape that is determined to be optimal for the particular sealing application, including, but not limited to, round, oval, square, or rectangular.

With continuing reference to FIG. 2, the seal member 10 may optionally be provided with one or more guide ribs 17 on the outer surface of the stem portion 11 to properly orient the seal member 10 within the outlet opening (e.g., 104) in which it is received. Depending upon the clearance between the walls of the opening (e.g., 104) in which the seal member 10 is received, that opening may further be provided with grooves (not shown) dimensioned to receive the one or more guide ribs 17 therein.

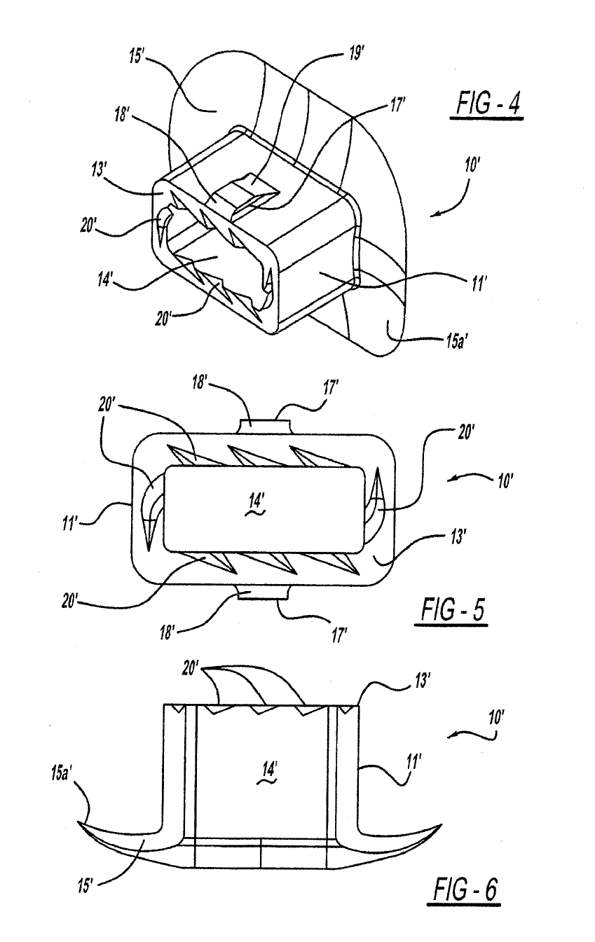

With reference now being had to FIGS. 4 through 6, in which an alternate embodiment of the inventive seal member 10′ is depicted, guide ribs 17′ may further be configured, such as with the illustrated forward taper 18′, so as to provide a ramp to facilitate insertion of the seal member into the opening in the upstream member (such as the inner member 100 of FIGS. 1a and 1b). A further reverse taper 19′ positioned oppositely of the taper 18′ may also be provided on each guide rib 17′ to act as a bias urging the peripheral edge 15a′ of flange 15′ into contact with the first surface (e.g., 103 of FIGS. 1a and 1b) of the inner member (e.g., 100 of FIGS. 1a and 1b). It will be understood that such biasing is preferred where the peripheral edge 15a′ of the flange 15′ is not otherwise in sufficient contact with the first surface of the upstream member so as to prevent such fluid migration between the peripheral edge 15a′ of flange 15′ and that first surface that would tend to reduce or equalize the pressure of the fluid acting on upper surface 16′ of the flange 15′. By urging the peripheral edge 15a′ into contact with the first surface of the inner member, it will be appreciated that the sealing face 13′ will simultaneously be urged further toward or, optionally, into provisional (i.e., non-sealing) contact with, the opposing surface of the downstream member.

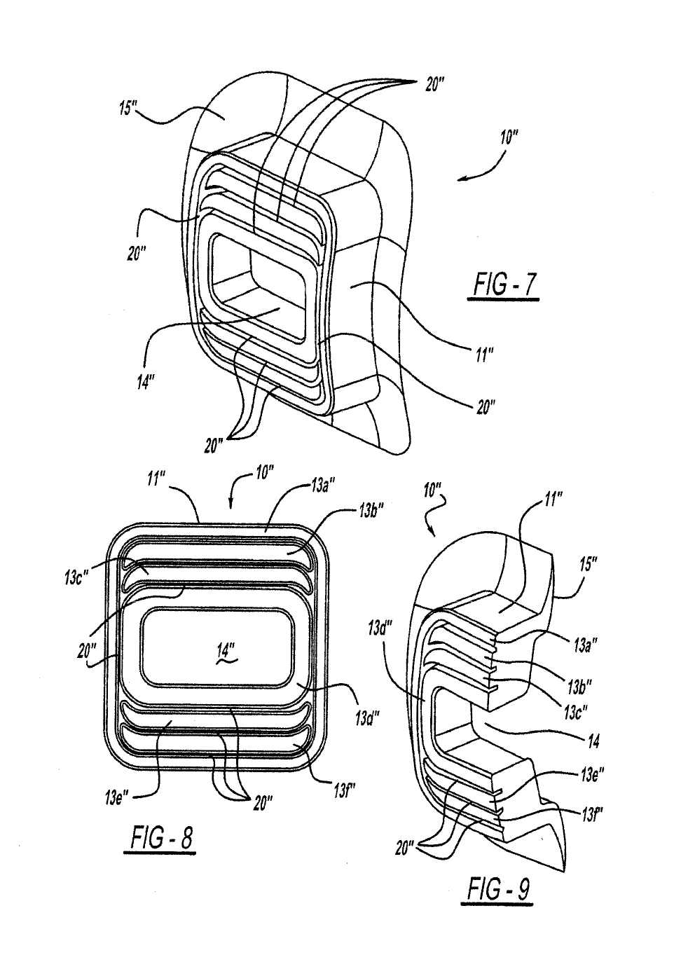

With continuing reference to FIGS. 4 through 6, the inventive seal member 10′ may further be provided with one or more grooves or channels 20′ defined on the sealing face 13′ thereof, such one or more grooves or channels allowing a fluid to enter the sealing interface between the sealing face 13′ and the opposing surface of the downstream member so as to provide lubrication and a controlled force countering the force generated by the fluid pressure on the flange 15′, thereby reducing friction between these surfaces. These grooves or channels 20′ may be discrete, such as shown in FIGS. 4 through 6, or may comprise a continuous channel or groove 20″ as shown in the alternate embodiment of FIGS. 7 through 9. Per the embodiment of FIGS. 4 through 6, the channels 20′ can be seen to comprise tapered indentations in the surface of the sealing face 13′, each indentation opening onto the surface defining passageway 14′ so that a supply of fluid may be communicated from the passageway 14′ and into each channel 20′. It will be understood that the dimensions of these channels can be varied to optimize their function depending on such considerations as the fluids, pressures, interface characteristics, etc.

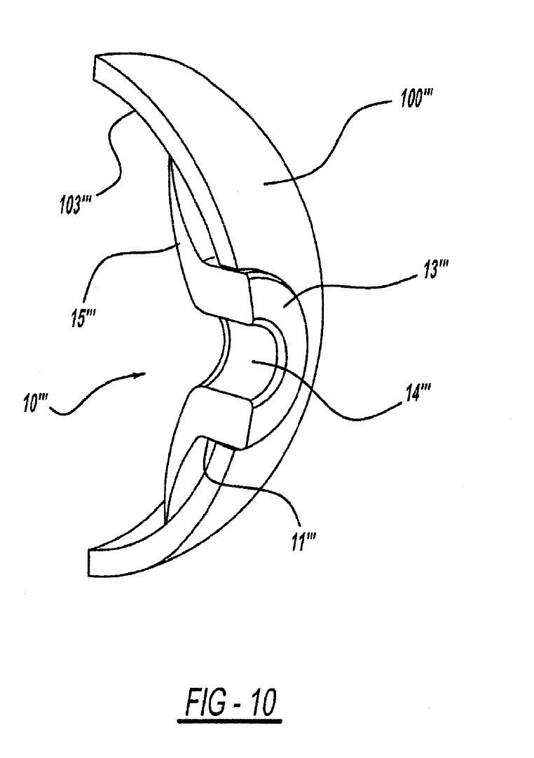

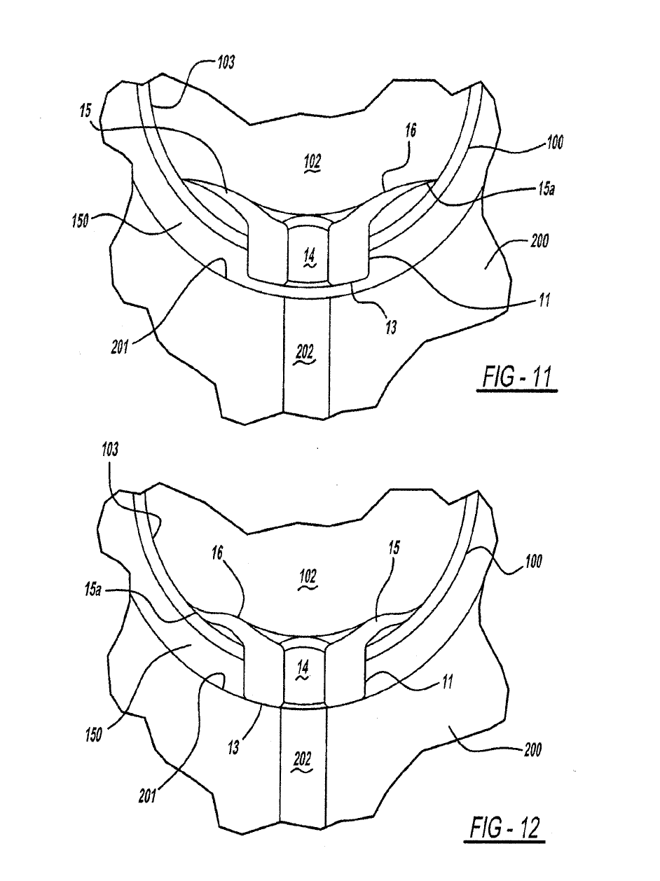

According to the embodiment of FIGS. 7 through 9, a single continuous channel 20″ is defined in the sealing face. Further to this embodiment, the arrangement of the various sections of the channel 20″ may be seen to divide the sealing face into a plurality of discrete sealing faces 13a″, 13b″, 13c″, 13d″, 13e″ and 13f″. This design is suited to applications, such as described herein, where the rotational position of the seal member 10″ in relation to the passageway defined in, and opening onto the opposing surface of, the downstream member is selectively varied in order to alter the dimensions of the fluid passage defined at this interface between passageway 14″ and the passageway in the downstream member. More particularly, as the rotational orientation of the seal member 10″ is varied (by, for instance, incremental rotary movement of the upstream member) in relation to the passageway defined in the downstream member, the sealing faces 13a″, 13b″, 13c″, 13d″, 13e″ and 13f″ successively enable a momentary closing of the passageway. It will be appreciated that the shape of the flange should be optimized to the geometry of the interior surface of the upstream member so as to facilitate formation of a fluid seal against that interior surface upon the application of sufficient fluid pressure. For instance, where that interior surface 103″′ of the inner member 100″′ is spherical, the cross-section shape of the flange 15″′ may take the form depicted in FIG. 10. Alternatively, where the interior surface of the upstream member is flat, at least proximate to the location of the seal member, the shape of the flange is such that at least the peripheral edge thereof lies along a common plane so as to ensure sealing contact with that interior surface.

Similarly, it will be understood that the surface geometry of the seal-member sealing-face should be optimized to the geometry of the opposing surface of the downstream member so as to form a fluid seal there against, whether the sealing face has to seal against a flat surface or, as with the illustrated sealing face 13″′ of FIG. 10, against the surface of a cylinder or sphere (not depicted).

It is contemplated that the inventive seal member may be formed from a polymer, such as, by way of non-limiting example, an elastomeric material such as Nylon 46, with such polymeric construction being especially suited to relatively lower pressure applications. For comparatively intermediate pressure environments, a more rigid polymer may be employed. And, for relatively higher pressure applications (such as, by way of example only, aircraft hydraulic control systems, for instance), it is contemplated that the seal member may be fashioned from materials such as metals with varying degrees of elasticity, glass, glass-like or ceramic materials (particularly for applications requiring extreme chemical resistance), known composites and synthetic materials, etc.

With the benefit of this disclosure, those skilled in the art will appreciate that the material from which the sealing member is fashioned will depend upon the fluid pressure applied to the flange of the sealing member and the desired deflection thereof in response to such pressure, as well as the characteristics of the fluid and the potential chemical interaction between the same and the seal member, the operating temperature of the environment in which the seal member is employed, etc.

Turning now to FIGS. 1a and 1b, as well as FIGS. 11 through 13, the inventive seal member as heretofore described may be employed, for example, in a rotary valve for selectively porting a fluid through one or more outlets, and thence to one or more downstream elements which may be actuated by such fluid (including, for instance, clutches). According to the exemplary embodiment of the downstream housing 200 and upstream inner-member 100 herein contemplated, the one or more components thereof may be formed from any suitably strong and rigid materials, including, by way of non-limiting example, metals such as aluminum, zinc, or magnesium, rigid polymers, including, for instance, reinforced (such as, for example, with fiberglass or carbon fiber) polymers. Relatedly, these one or more components may be formed by any conventional means, including, without limitation, die-casting. As will be appreciated from this disclosure, the downstream and upstream members need not be deformable in the manner described in United States published application 2007/0107787, since the inventive seal member is itself deformable under pressure as described herein to create sealing contact between the upstream and downstream members across the intermediate space that separates them. Referring specifically to FIGS. 1a and 1b, where the upstream member constitutes the inner member 100 heretofore described, it will be seen that a plurality of seal members 10 are positioned in the outlet openings 104 provided therethrough, each such seal member having, as noted, a passageway 14 through the stem portion 11 which may be selectively radially aligned with an outlet passageway defined through the downstream housing (not shown) in which the upstream member 100 is disposed.

Referring also to FIGS. 11 and 12, by rotational movement of the upstream member 100 relative to the downstream housing 200, each of one or more of the seal members 10 is oriented so that its passageway 14 is aligned with one of a plurality of passageways 202 in the housing 200 (FIG. 11); the remaining seal members 10 (not shown) in this orientation are not so aligned, but are instead positioned to oppose surfaces 201 of the downstream housing 200 lacking outlet passageways. A fluid under pressure thereafter introduced into the interior cavity 102 of the upstream member 100 acts against the upper surface 16 of each flange 15 as the fluid simultaneously leaves the interior cavity 102 via the passageways 14. By the configuration thereof as shown and described, flange 15 becomes gradually flattened against the first surface 103 of the upstream member 100, from the peripheral edge 15a and proceeding radially inwardly toward the increasingly thicker portion of the flange, thus “grounding” successively more of the flange 15 against that interior surface 103 and reducing the rate at which additional force applied by the increasing fluid pressure is transferred to the seal member 10. Concurrently, the stem portion 11 is moved within opening 104 until the sealing face 13 comes into sealing contact with the opposing surface 201 of the downstream housing 200 across the intermediate space 150 (FIG. 12).

Where the seal member 10 is positioned in alignment with an outlet passageway 202 in the downstream housing, such as shown in FIGS. 11 and 12, the fluid is communicated from the interior cavity 102 to the outlet passageway 202 via the passageway 14. Where, in contrast, the seal member 10 is misaligned relative to any of the outlet passageways 202, sealing contact between the sealing face 13 and the surface 201 of the housing 200 results in the fluid being trapped in the passageway 14.

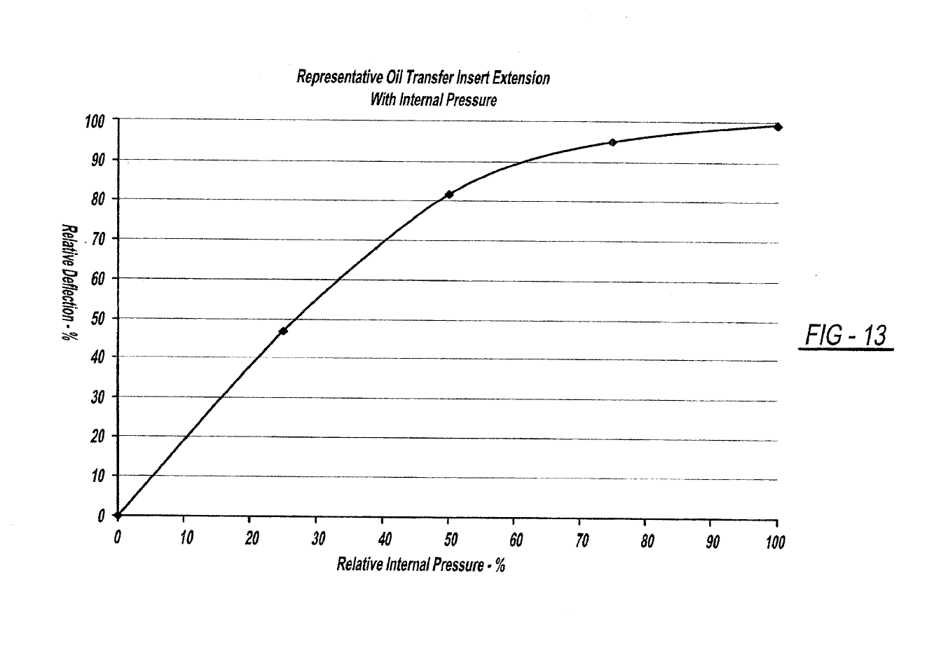

By the configuration thereof as shown and described, flange 15 is able to provide a positive seal against the first surface (e.g., 103) of the upstream member (e.g., inner member 100) with a minimum of pressure applied to the upper surface 16 thereof and, moreover, as fluid pressure acting on surface 16 is increased, the flange 15 becomes gradually flattened against that first surface, from the peripheral edge 15a and proceeding radially inwardly toward the increasingly thicker portion of the flange, thus “grounding” successively more of the flange 15 against the interior surface 103 of the upstream member 100 and reducing the rate at which additional force applied by the increasing fluid pressure is transferred to the seal member 10. Also by configuration of the flange 15 as described herein, the rate of increase in pressure exerted on the seal member 10 forcing the sealing face 13 against the opposing surface 202 of the downstream member 200 gradually decreases as the delivery pressure of the fluid rises. This behavior of the flange is shown graphically in FIG. 13, which depicts a representative curve, derived from experimental data, plotting the relationship between the relative (as a percentage) fluid pressure acting on the seal-member flange and the relative deflection (also as a percentage) of the seal member of the flange.

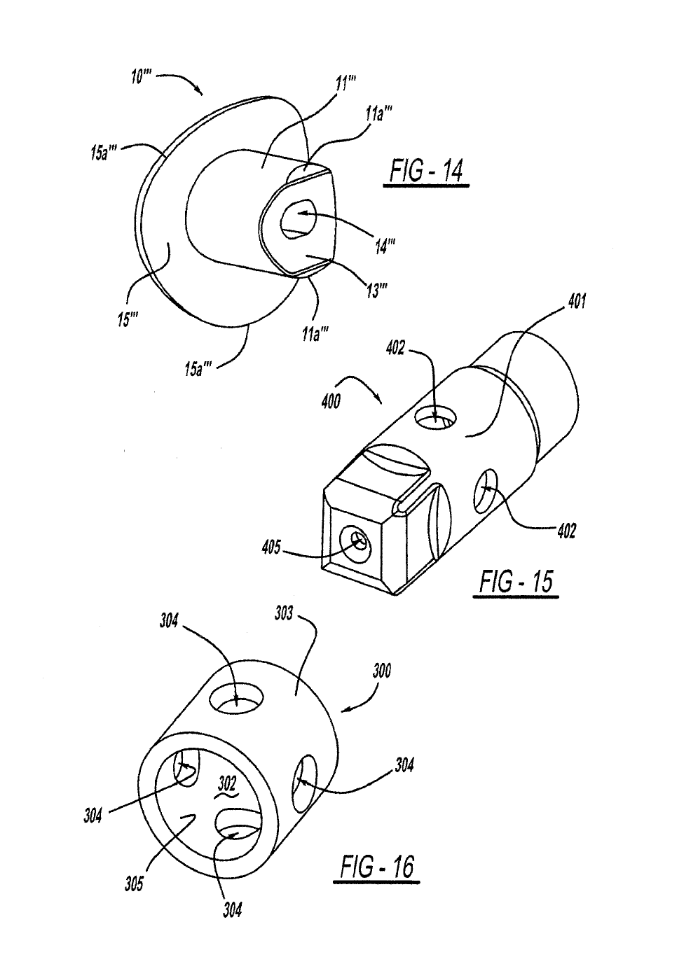

Referring next to FIGS. 14 through 18, there is shown an alternative embodiment wherein the upstream member comprises outer member 300 and the downstream member comprises an inner member 400 disposed therein, and wherein further one or more seal members 10″′ are movably positionable in a corresponding opening 304 defined through the upstream member 300. Still more particularly, upstream member 300 according to the illustrated embodiment comprises a cylindrically-shaped member having opposite first 303 and second 305 surfaces, and defining an interior cavity 302. One or more openings 304 defined through upstream, outer member 300 between the opposing surfaces 303 and 305 are provided, each such opening receiving the stem portion 11″′ of a seal member 10″′. As shown, a plurality of openings 304 are provided in the outer member 300 of the illustrated embodiment, one for each of a plurality of seal members 10″′, the openings being disposed equidistant from each other about the circumference of the outer member.

Disposed within cavity 302, and separated from outer member 300 by intermediate space 350 is the downstream, inner member 400. As depicted, inner member 400 takes the form of a stem having a longitudinal passageway 405 and at least one passageway 402 extending from an opening at outer surface 401 and inwardly into communication with longitudinal passageway 405. As shown, a plurality of such passageways 402 are provided in the inner member 400 of the illustrated embodiment, the openings thereof being disposed equidistant from each other about the circumference of the inner member and the passageways being in radial alignment with the openings 304.

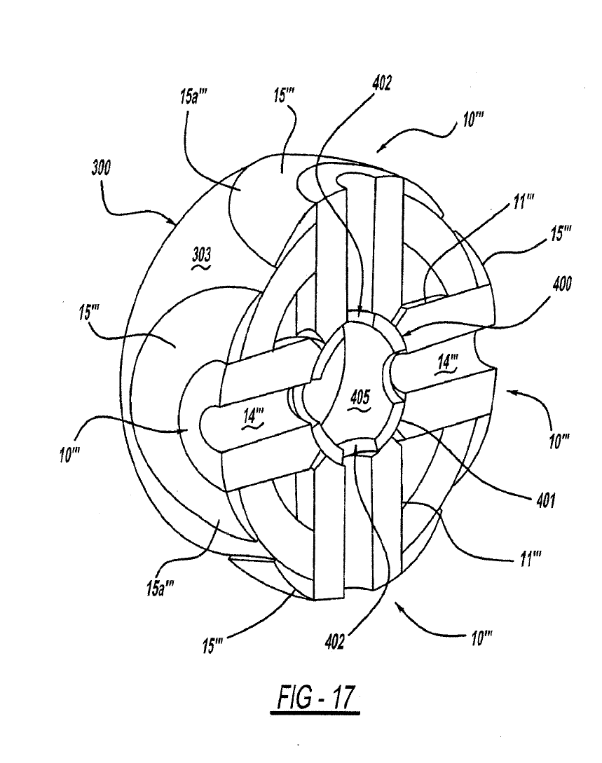

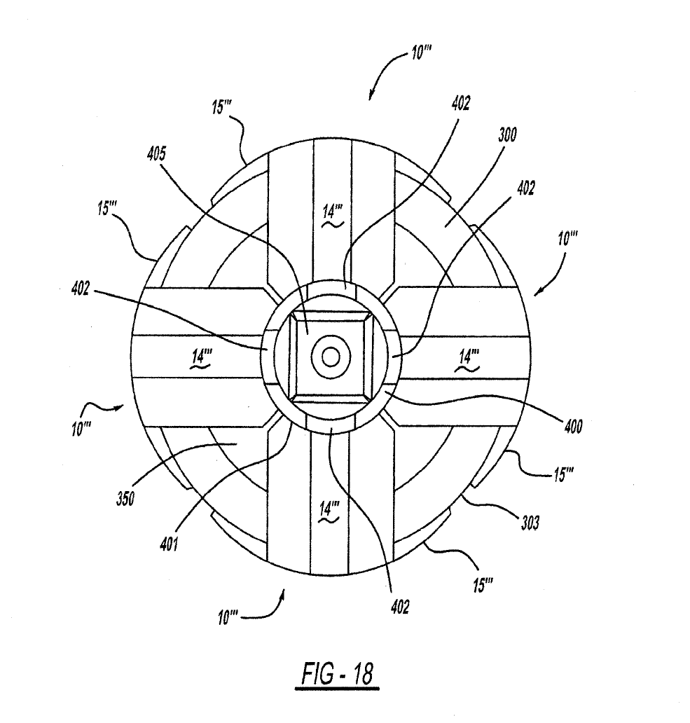

Except as otherwise noted, seal member 10″′ is as heretofore described, and includes an annular flange 15″′ of concave cross-section (as viewed from the top down where the flange 15″′ defines the top of the seal member 10″′ and the sealing face 13″′ defines the bottom) extending radially from a central axis of the seal member 10″′ defined coaxially with the longitudinal axis of the passageway 14″′. Referring particularly to FIGS. 17 and 18, flange 15″′ is characterized by a tapered thickness proceeding radially outwardly from the said central axis to the flange peripheral edge 15a″′. A fluid passageway 14″′ is defined through the stem portion 11″′ between the flange 15′″ and the sealing face 13″′.

In order that the seal members 10″′ of this embodiment of the invention perform comparably to the seal members as heretofore described, it will be appreciated that the annular flange 15″′ of each seal member 10′″ has a smaller radius in cross-section than that of the upstream outer member 300. In this fashion, the flange 15″′ of each seal member 10″′ may be deformed under fluid pressure to increase the area of contact between the flange and the first surface 303 of the upstream member 300 and to simultaneously move the stem portion 11″′ within the opening defined in the upstream member 300 so as to bring the sealing face 13″′ into sealing contact with an opposing surface 401 of the downstream member 400 across the intermediate space 350.

Inner member 400 is rotatably moveable (by any conventional means appropriate to the application) relative to the outer member 300, so that the sealing faces 13′″ may selectively be opposed by, and in radial alignment with, an opening of a respective one of the passageways 402 or the outer surface 401 of inner member 400 disposed intermediate those passageways 402. In this fashion, as those skilled in the art will appreciate, fluid communication between the outer 300 and inner 400 members may be selectively attenuated.

Per the illustrated embodiment, wherein a plurality of seal member 10′″ are provided, opposite sides of the stem 11″′ of each seal member 10″′ proximate the sealing face 13′″ may be chamfered 11a″′. According to this modification, as shown best in FIGS. 17 and 18, chamfered surfaces 11a″′ of adjacent seal members 10″′ are opposed so that each seal member 10″′ may be brought into sealing contact with opposing surface 401 of the downstream member 400 without interference from an adjacent seal member 10″′.

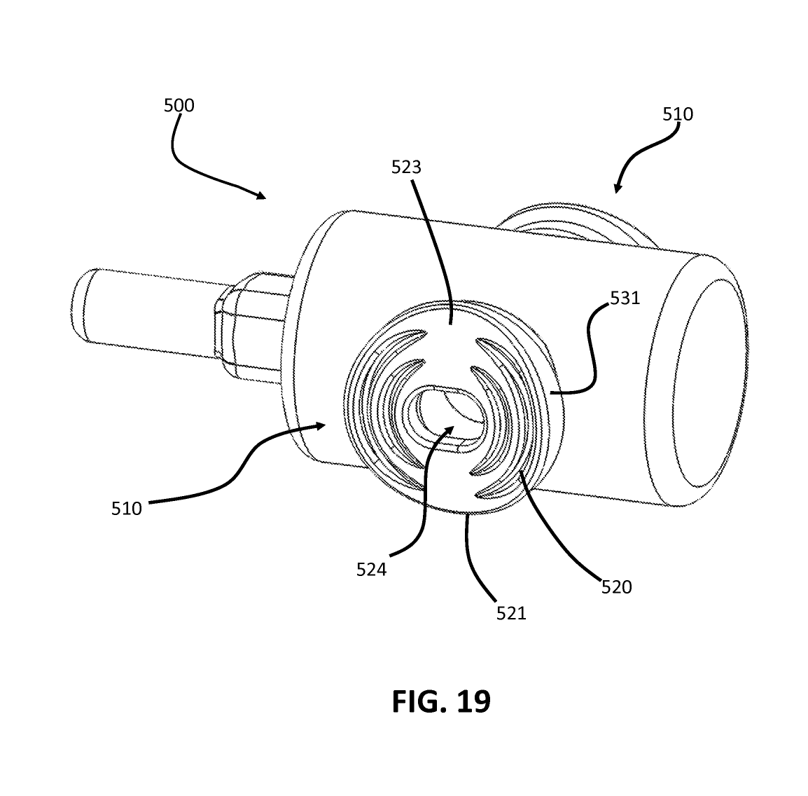

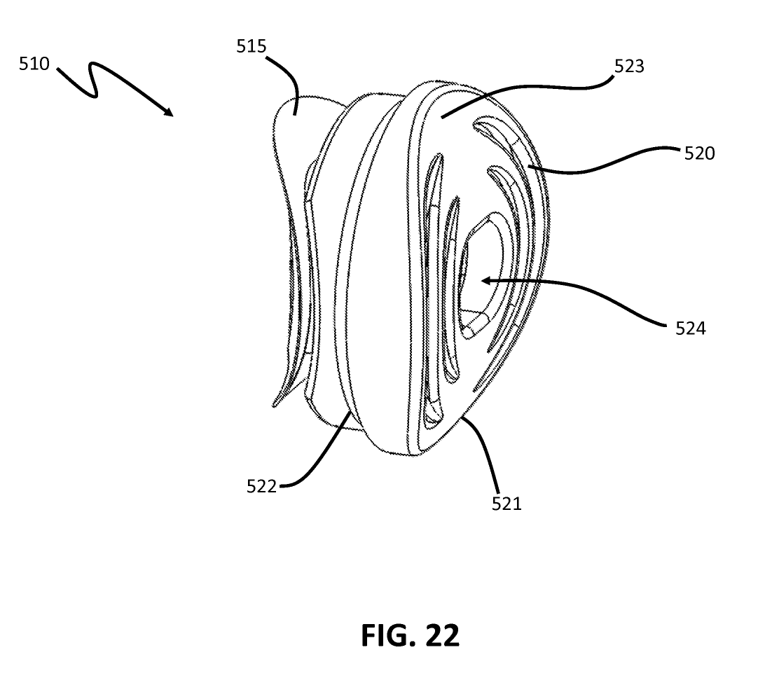

With reference to FIGS. 19 through 23, a further exemplary embodiment is shown wherein a seal assembly 510 is provided for selectively completing a fluid passageway defined between an upstream member 500 and a downstream member (not shown) separated by an intermediate space, the seal assembly movably positionable in an opening defined through the upstream member between opposite first and second surfaces thereof. Generally, the seal assembly 510 comprises a resiliently deformable, radially-extending flange 515 provided at a first end of the seal assembly; a sealing face 523 provided at an opposite, second end of the seal assembly; and a fluid passageway extending through the seal assembly between the flange 515 and the sealing face 523.

As with the above-described embodiments of FIGS. 1-18, flange 515 is deformable under fluid pressure to increase the area of contact between the flange and the first surface of the upstream member and to simultaneously move the seal assembly within the opening defined in the upstream member so as to bring the sealing face into sealing contact with an opposing surface of the downstream member across the intermediate space. As shown in all exemplary embodiments, the radially-extending flange is characterized by a tapered thickness proceeding radially outwardly from the central axis of the seal assembly to a peripheral edge of the flange.

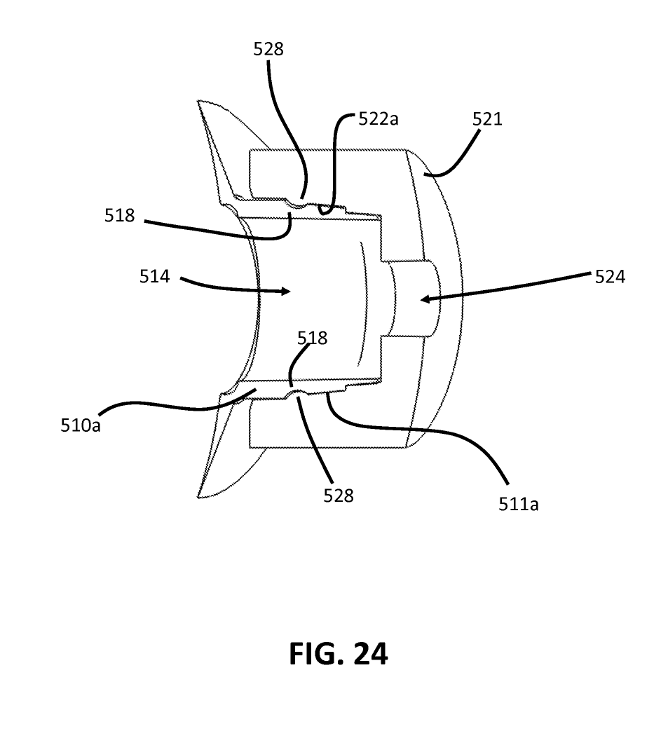

According to the embodiment of FIGS. 19 through 23 (as well as FIGS. 24-27b) the seal assembly is comprised of at least two axially mating portions, one of the at least two axially mating portions comprising the flange 515 and the other of said at least two axially mating portions comprising the sealing face 523. More particularly, and with continuing reference to the embodiment of FIGS. 19 through 23, the at least two axially mating portions include a seal member 510a and a cover member 521. In this example, an upstream member is illustrated for the fluid transfer system is in the form of an inner member 500 having an exterior surface 501, an interior cavity 502 defined by an interior surface 503, and at least one outlet opening 504 defined therethrough for use with a rotary valve. A seal assembly 510 is provided in each opening 504.

Seal assembly 510 includes a seal member 510a mounted and engaged to a cover member 521. Cover member 521 allows for increased surface area contact with the interior surface of the downstream outer member. The cover member 521 can be fabricated to have a larger sealing face as compared to the sealing face of the seal member according to the embodiments of FIGS. 1-18, thus providing a greater surface area for contact with the downstream member. In this example, a pair of oppositely positioned seal assemblies 510 are shown. However, it is within the scope of this disclosure to utilize any number of seal assemblies 510, depending on the particular application.

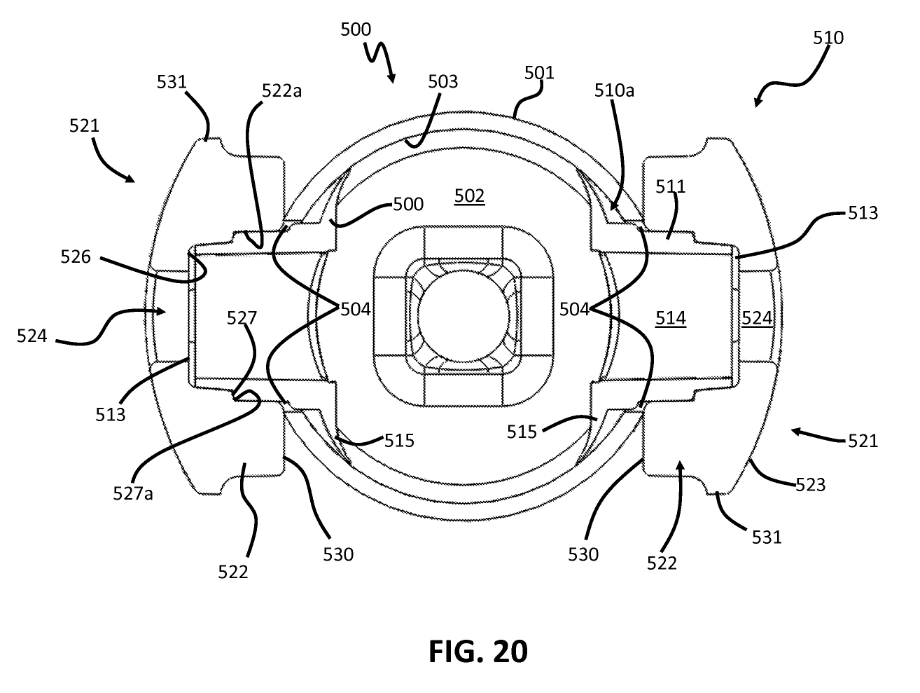

Seal member 510a corresponds to the seal members previously described with respect to FIGS. 1 through 18. Seal assemblies 510 are shown in an exemplary operational environment comprising a rotary valve for a vehicle automatic transmission system such as heretofore described. Each seal assembly 510 (shown in cross-section in FIGS. 20, 21 and 23) may be seen to basically comprise a seal member 510a sealably engaged with a cover member 521. Seal member 510a is provided through the opening 504 of the inner member 500. Cover member 521 is mounted on seal member 510a in a space adjacent to exterior surface 501 of inner member 500. At least one of the seal member 510a and the cover member 521 includes a stem portion defining at least a portion of the fluid passageway through the seal assembly, the stem portion axially mating with the other of the seal member or the cover member. Per the illustrated embodiment, the seal member includes an elongate stem portion, and the cover member includes a cover stem portion defining an interior bore sized to at least partially receive therein the elongate stem portion, as described below.

Each seal member 510a includes an elongate stem portion 511 having an exterior surface 511a dimensioned to be movably positionable in the outlet opening 504, a resiliently-deformable flange 515 provided at one end of the stem portion 511, a face 513 provided at the opposite end of the stem portion 511, and a fluid passageway 514 defined through the stem portion between the flange and the sealing face and at least partially defining the fluid passageway through the seal assembly.

Cover member 521 is provided to form a seal when contacting an opposed interior surface of a corresponding downstream member in the presence of fluid pressure causing increased contact of flange 515 against the interior surface 503 of inner member 500. Cover member 521 includes a cover stem portion 522 having an interior bore defining an interior mounting surface 522a extending from a base end 530 to a sealing face 523. The stem portion 522 further includes an opening through the sealing face 523 which defines second fluid passageway 524 extending through the stem portion and substantially axially aligned with fluid passageway 514 defined through the seal member 510a. The opening defining passageway 524 defines a portion of the fluid passageway of the seal assembly.

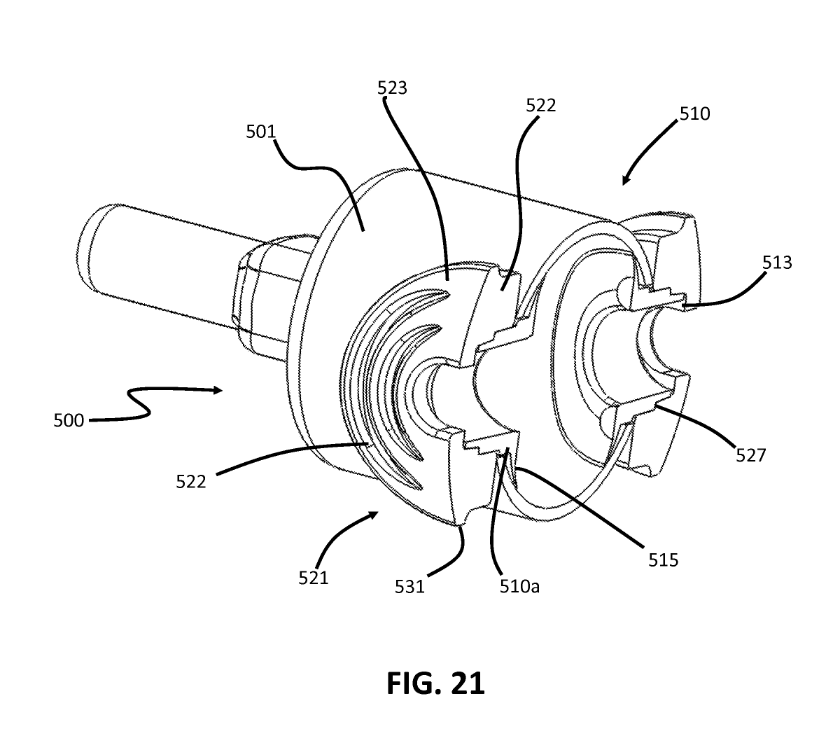

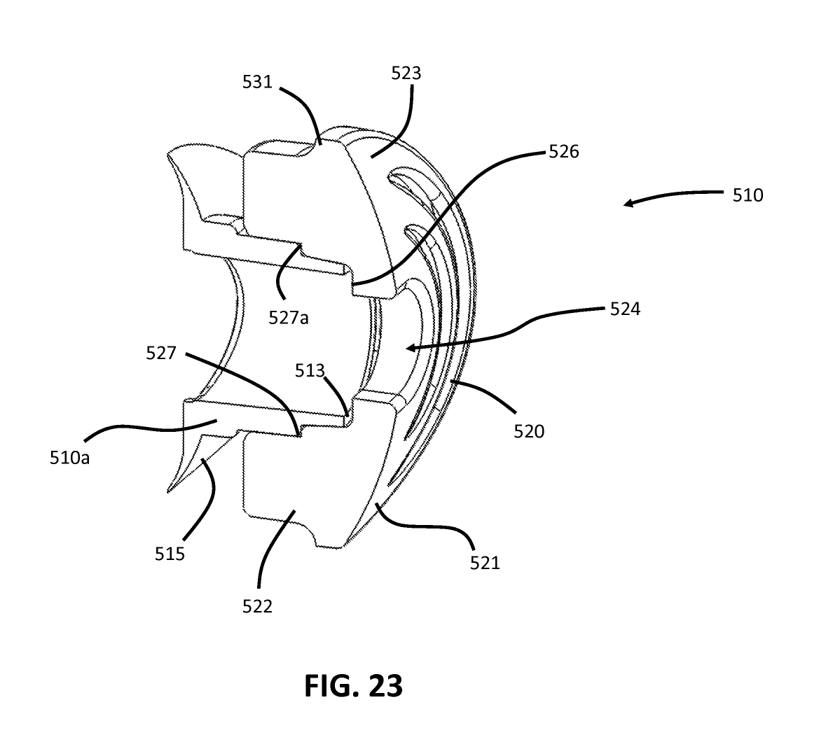

The exterior surface of the elongate stem portion of the seal member is complimentary in shape to the shape of the interior bore of the cover member. More particularly, the interior mounting surface 522a is sized and shaped as a mating surface to correspond to the exterior surface 511a of the seal member 510a such that surface 522a and 511a are in intimate surface contact forming a seal thereof. Accordingly, a sealing engagement occurs when cover member 521 is mounted to seal member 510a. In an exemplary embodiment, as shown in FIGS. 21 and 23, a cross section diameter of the fluid passageway 524 is relatively less than the cross section diameter of fluid passageway 514 defined through the seal member.

In an example, referring to FIGS. 20, 21, and 23, interior surface 522a of the cover member stem portion 522 includes an annular stop 527 formed at a spaced apart distance from the sealing face 523 that abuts a corresponding annular stop 527a formed on the exterior surface 511a of seal member 510a, the stop spaced away from the annular face 513. The stop 527 can be formed along the interior surface 522a spaced between opposed sealing face 523 and base 530. Cover member 521 is mounted over and around seal member 510a such that the corresponding stops contact each other forming a mounting engagement. In this example, annular face 513 of seal member 510a abuts an interior, annular stop or shelf 526 formed along the interior surface 522a adjacent and internally opposite to the second sealing face 523. As shown in FIGS. 21-23, cover member 521 can further include a peripheral rim body 531 extending radially outward from the cover stem portion 522 such that a cross section area of the rim body 531 is greater than a cross-sectional area of the cover stem portion. The sealing face 523 is formed at the end portion of the rim body 531. Accordingly, cover 521 provides a greater sealing surface area contact with the downstream member when a sealing is formed as a result of the increased sealing face 523 surface area.

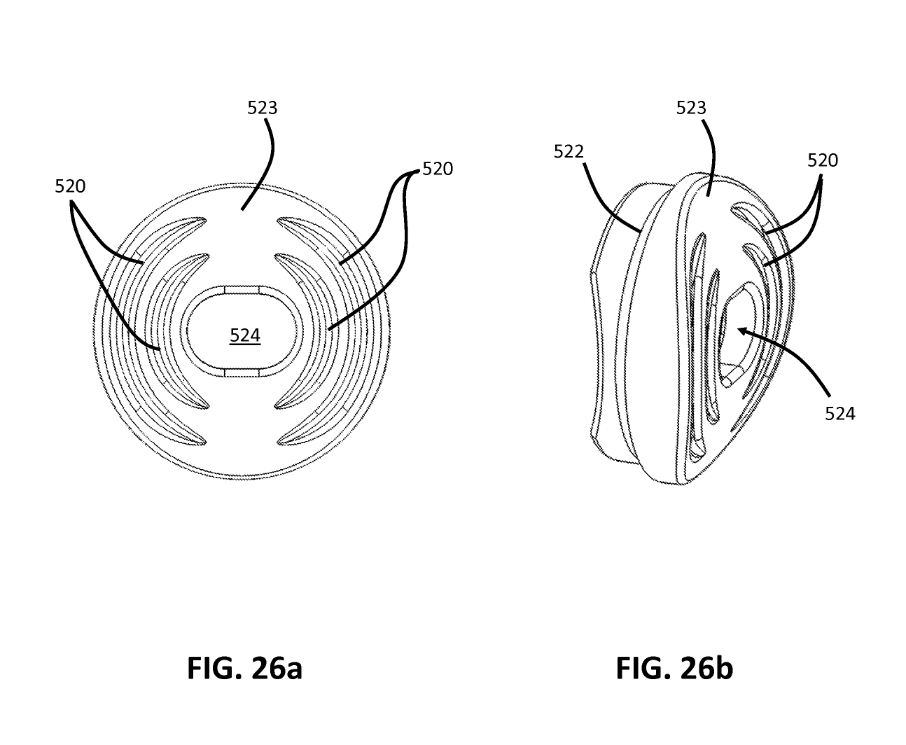

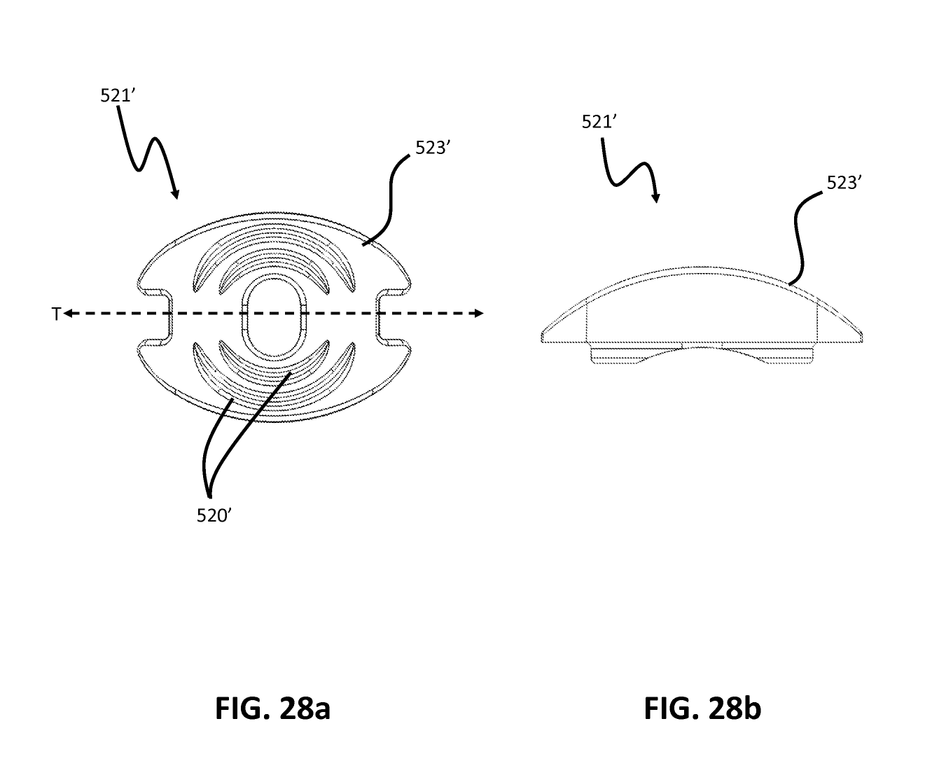

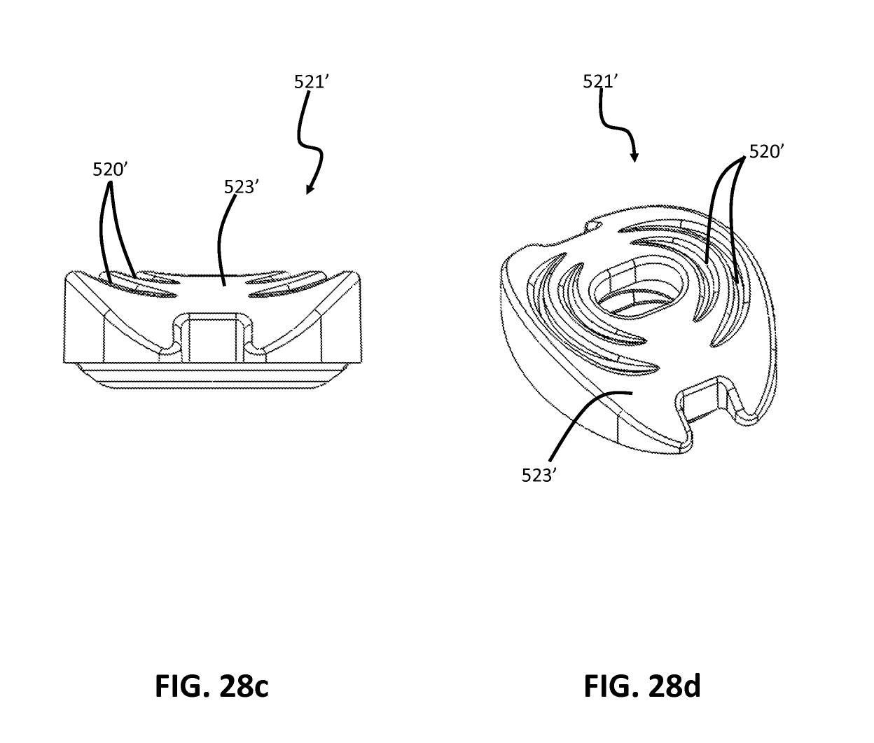

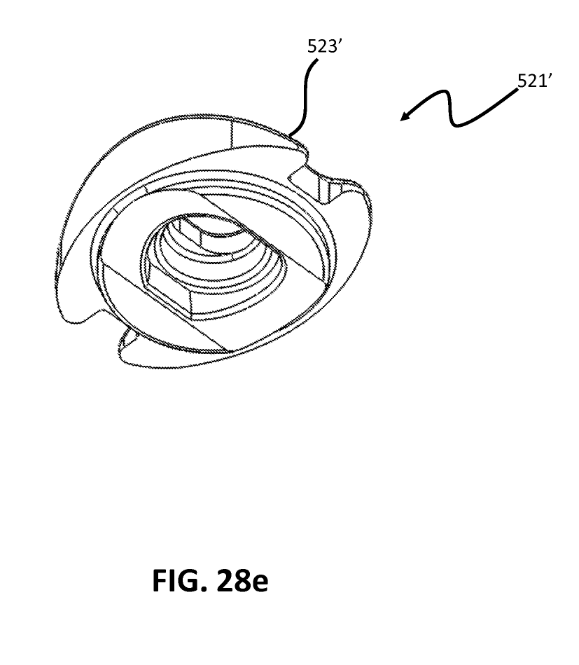

While the shape of the cover 521 is generally circular when viewed from the face thereof, as shown in FIG. 26a, for example, it is also contemplated, as shown in FIGS. 28a-28e, that the cover 521′ may be configured so that the sealing face 523′ has a more ovoid geometry characterized by the extension of the sealing face 523′ along the axis of travel T of the seal member during rotary movement of the upstream member 500 relative to the downstream member (or vice-versa, in the case of a rotary valve assembly where the downstream member moves relative to a stationary upstream member). By such construction, as those skilled in the art will appreciate, sealing face 523′ provides a greater surface area contacting the downstream member and provides resistance to tipping of the sealing face in response to torque created by friction between the sealing face 523′ and the opposing surface of the downstream member.

As shown in the exemplary cover of FIGS. 28a-28e, the cover member of that embodiment is further characterized by a convex shape (see, e.g., FIG. 28b-28d) to compliment, according to the illustrated embodiment, the curved opposing surface of the downstream member. Of course, it will be appreciated from this disclosure that the shape of the cover member may be other than convex, depending upon the geometry of the opposing surface of the downstream member with which the sealing face of the cover member comes in contact.

Sealing face 523 may further be provided with one or more lubricating grooves or channels 520 defined on the second sealing face 523 thereof, such one or more grooves or channels dimensioned to permit a fluid to enter the sealing interface between the second sealing face 523 and the opposing surface of the downstream member so as to provide lubrication and a controlled force countering the force generated by the fluid pressure on the flange 515, thereby reducing friction between these surfaces.

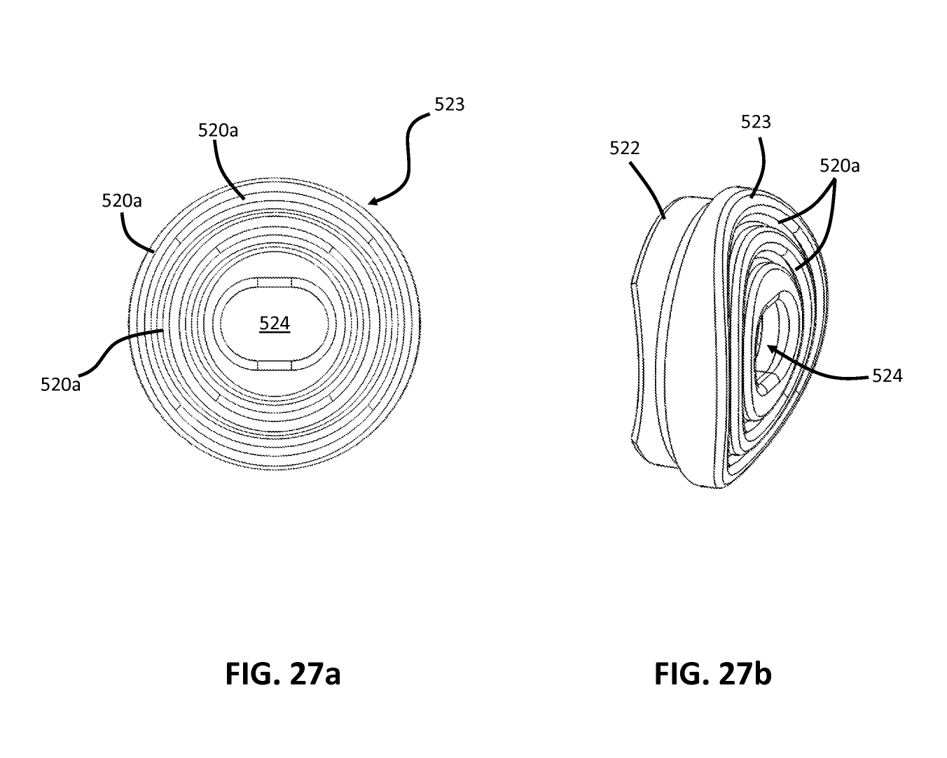

These grooves or channels 520 may be partial grooves surrounding the fluid passageway 524, such as shown in FIGS. 19, 21, 22, 23, 26a, 26b, 28a and 28c-28d (wherein the one or more grooves comprise a plurality of discrete grooves partially surrounding the opening through the cover member) or may comprise one or more continuous circular channels or grooves 520a as shown in the alternate embodiments of FIGS. 27a and 27b. Per the embodiments of FIGS. 27a and 27b, the channels 520 and 520a can be seen to comprise tapered indentations in the surface of the sealing face 523, each indentation opening onto the surface defining passageway 524 so that a supply of fluid may be communicated from the passageway 524 and into each channel 520 and 520a. It will be understood that the numbers and/or dimensions of these channels can be varied to optimize their function depending on such considerations as the fluids, pressures, interface characteristics, etc.

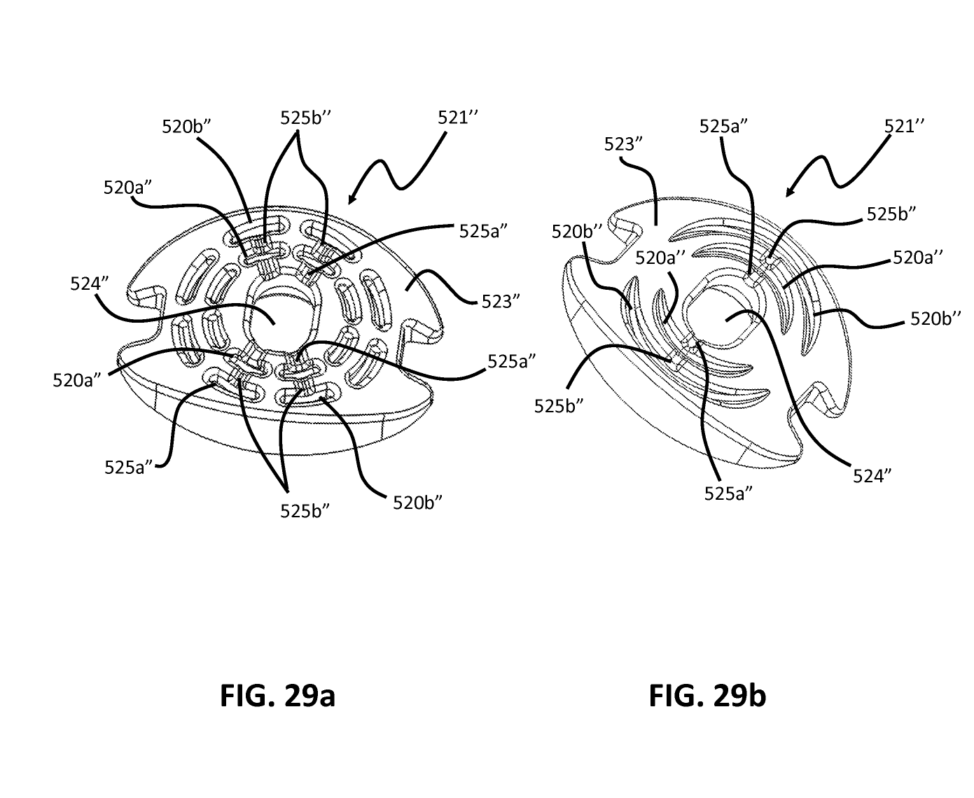

Grooves or channels 520 and 520a will be understood to provide for lubrication of the interface between the seal face and the downstream member, as well as for trapping debris. Furthermore, it is contemplated that the grooves or channels 520 and 520a may be selectively provided fluid from the fluid passage 524 to finely adjust the balance of pressures on either side of the sealing member to assure optimal sealing with minimum friction between the seal face and the downstream member. In these regards, FIGS. 29a and 29b depict two exemplary alternative embodiments of the present invention according to which one or more grooves or channels 520″ in the sealing face 523″ are in direct fluid communication with the fluid passage 524″ via feed channels 545.″ According to the embodiment of FIG. 29a more particularly, channels 520″ comprise a plurality of discrete, arcuate grooves arranged about the sealing face 523″ in two concentric, circular rows. As depicted, only select ones of these channels 520″ are supplied with fluid via the feed channels 525″. More specifically, it can be seen from FIG. 29a that first pairs of oppositely arranged fluid channels 525a″ in direct communication with the fluid passageway 524″ feed fluid to pairs of the radially innermost channels 520a″, while second pairs of feed channels 525b″ aligned with the first pair of feed channels 525a″ extend between the pairs of radially innermost channels 520a″ and adjacent pairs of radially outermost channels 520b″.

On the other hand, the embodiment of FIG. 29b depicts a cover 521″ in which the grooves of channels 520″ are discrete, arcuate grooves similar to those discussed in relation to the embodiment of FIGS. 26a and 26b, and shown in other drawings of the invention referenced herein. In this embodiment, each of the channels 520″ may be seen to be in direct fluid communication with the fluid passage 524″ via feed channels 525″. More specifically, it can be seen from FIG. 29b that a first pair of oppositely arranged fluid channels 525a″ in direct communication with the fluid passageway 524″ feed fluid to the radially innermost pair of channels 520a″, while a second pair of feed channels 525b″ aligned with the first pair of feed channels 525a″ extend between the radially innermost pair of channels 520a″ and the radially outermost pair of channels 520b″.

Of course, it will be understood from the foregoing that any number of one or more feed channels of desired dimensions and geometries may be employed to directly communicate fluid to any one or more of the channels provided in the sealing face of the cover, to achieve at the sealing face an optimal counter-pressure to that pressure acting on the seal member.

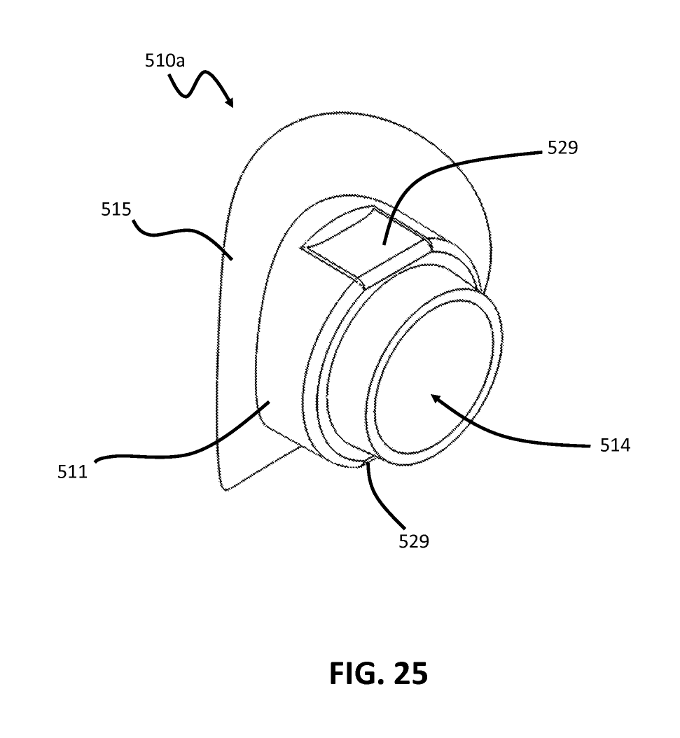

With reference to FIGS. 24 and 25, in a further exemplary embodiment, seal assembly 510 includes a locking feature provided on the seal member that engages a corresponding locking feature formed on the cover member. In the illustrated embodiment, the cover member includes a protruding boss feature 528 adapted to be received by a mating indentation 518 provided on the exterior surface seal member. The protruding boss is formed on the interior surface 522a of the cover member 521 and extends toward the exterior contact surface of seal member 510a such that when mounting cover 521 onto seal member 510a, the boss feature 528 will slide into place locking cover 521 in sealing engagement with seal member 510a. The indentation 518 is formed along the exterior surface 511a of the elongate stem 511 of seal member 510a. The boss 528 alignment and mating with indentation 518 secures the separate cover member to the seal member and provides for desired alignment of the fluid passageways as well as desired sealing contact between the contacting surfaces.

Of course, the disposition of the protruding boss feature 528 and mating indentation 518 may be reversed from that of the exemplary embodiment of FIG. 24. In other words, the protruding boss may be formed on an exterior surface of the seal member 510a and the indentation may be formed on the interior surface of the cover member 521.

FIG. 25 provides for an alternative embodiment wherein one of the elongate stem portion of the seal member and the cover member further includes a locating feature sized to engage a complimentary surface formed on the other of the cover member or the elongate stem portion of the seal member, the locating feature and complementary surface positioned so that, when engaged, the axially mating portions of the seal assembly are mated in predefined radial orientation relative to each other. According to the illustrated embodiment more particularly, a cover to body locating feature 511 is defined along a portion of the stem portion 511. This allows for proper alignment when mounting the cover member to the seal member and restricts rotational movement of one member relative to the other. The locking features of FIG. 24 also restrict rotational movement. In the embodiment of FIG. 25, the locating feature is shown to be a flat section relative to a rounder surface defined along the exterior surface 511a of stem portion 511.

It is contemplated that the inventive seal assembly and particularly the cover member may be formed from a polymer, such as, by way of non-limiting example, an elastomeric material such as Nylon 46, with such polymeric construction being especially suited to relatively lower pressure applications. For comparatively intermediate pressure environments, a more rigid polymer may be employed. And, for relatively higher pressure applications (such as, by way of example only, aircraft hydraulic control systems, for instance), it is contemplated that the seal assembly may be fashioned from materials such as metals with varying degrees of elasticity, glass, glass-like or ceramic materials (particularly for applications requiring extreme chemical resistance), known composites and synthetic materials, etc.

In this example, an upstream member is illustrated for the fluid transfer system is in the form of an inner member 500 having an exterior surface 501, an interior cavity 502 defined by an interior surface 503, and at least one outlet opening 504 defined therethrough for use with a rotary valve. A seal assembly 510 is provided in the opening 504. Seal assembly 510 includes a seal member 510a mounted and engaged to a cover member 521. Cover member 521 allows for increased surface area contact with the interior surface of the downstream outer member. In this example, a pair of oppositely positioned seal assemblies 510 are provided. However, it is within the scope of this disclosure to include inner members with one or more openings for receiving an example seal assembly 510.

With the benefit of this disclosure, those skilled in the art will appreciate that the material from which the sealing assembly is fashioned will depend upon the fluid pressure applied to the flange of the sealing member and the cover member and the desired deflection thereof in response to such pressure, as well as the characteristics of the fluid and the potential chemical interaction between the same and the seal assembly, the operating temperature of the environment in which the seal assembly is employed, etc.

From the foregoing description, it will be appreciated that the inventive sealing member addresses the disadvantages attending prior art sealing means in fluid transfer systems of the type wherein a fluid is selectively transferred through a fluid passageway defined between an upstream member and a downstream member separated by an intermediate space, by creating a sealing system that is dynamic in that it increases pressure at the sealing face while gradually and uniformly reducing the rate at which pressure is increased between the sealing face and the surface against which it seals, minimizing the increase of friction and resistance to movement while maintaining sealing contact. The sealing member thus is capable of compensating for considerable differences in component clearances and dimensional variations, even if the fluid transfer system in which it is employed experiences greatly varying pressures. Furthermore, the seal assembly of the present invention provides the possibility of creating greater counter-pressure on the downstream side of the seal member, thereby allowing more controlled balancing of pressures (upstream and downstream) to optimize sealing, while also reducing friction at the interface of the seal assembly and the downstream component of the valve system.

The foregoing description of the exemplary embodiments of the invention have been presented for purposes of illustration and description. They are not intended to be exhaustive of, or to limit, the invention to the precise forms disclosed, and modifications and variations are possible in light of the above teachings or may be acquired from practice of the invention. For instance, and without limitation, those skilled in the art will appreciate from the disclosure herein provided that the inventive seal member may be employed in an operational environment where the first surface of the upstream member against which the flange of the seal member is deformed under fluid pressure is characterized by a substantially flat geometry, as opposed to the curved geometries herein exemplified. Relatedly, it will be appreciated that while the exemplary embodiments of the invention show the seal member in an operational environment comprising a rotary valve characterized by radial flow, the present invention may be readily adapted to other operational environments including, without limitation, valves characterized by longitudinal, rather than radial, flow, such that the seal member(s) are provided in longitudinal ends walls of the valve and seal against substantially flat, rather than radiused, surfaces.

Thus, the embodiments shown and described are provided to explain the principals of the present invention and its practical application so as to enable one skilled in the art to utilize the invention in various embodiments and with various modifications as are suited to a particular use that may be contemplated. Accordingly, all such modifications and embodiments are intended to be included within the scope of the present invention. Other substitutions, modifications, changes and omissions may therefore be made in the design, operating conditions and arrangement of the exemplary embodiments without departing from the spirit of the present innovations.

1. A seal assembly for selectively completing a fluid passageway defined between an upstream member and a downstream member separated by an intermediate space, the seal assembly movably positionable in an opening defined through the upstream member between opposite first and second surfaces thereof, the seal assembly comprising:
a resiliently deformable, radially-extending flange provided at a first end of the seal assembly;
a sealing face provided at an opposite, second end of the seal assembly; and
a fluid passageway extending through the seal assembly between the flange and the sealing face;
wherein the flange is deformable under fluid pressure to increase the area of contact between the flange and the first surface of the upstream member and to simultaneously move the seal assembly within the opening defined in the upstream member so as to bring the sealing face into sealing contact with an opposing surface of the downstream member across the intermediate space; and
wherein the seal assembly is comprised of at least two axially mating portions, one of said at least two axially mating portions comprising the flange and the other of said at least two axially mating portions comprising the sealing face.

2. The seal assembly of claim 1, wherein the at least two axially mateable portions comprise:
a seal member including the resiliently deformable, radially-extending flange;
a cover member including the sealing face; and
at least one of the seal member and the cover member including a stem portion defining at least a portion of the fluid passageway through the seal assembly, the stem portion axially mating with the other of the seal member or the cover member.

3. The seal assembly of claim 2, wherein the seal member includes an elongate stem portion, and the cover member includes a cover stem portion defining an interior bore sized to at least partially receive therein the elongate stem portion, and wherein further the cover member includes an opening through the sealing face in fluid communication with the interior bore, the opening through the sealing face defining a portion of the fluid passageway.

4. The seal assembly of claim 3, wherein the exterior surface of the elongate stem portion of the seal member is complimentary in shape to the shape of the interior bore of the cover member.

5. The seal assembly of claim 3, wherein the elongate stem portion of the seal member terminates at an annular face that abuts an opposing annular shelf defining the bottom of the interior bore of the cover member.

6. The seal assembly of claim 3, wherein the interior surface of the cover member defines an annular stop formed at a spaced apart distance from the sealing face and the exterior surface of the seal member defines a second annular stop spaced away from the interior shelf and wherein the annular stops rest against one another when the cover member is mounted on the seal member.

7. The seal assembly of claim 2, wherein the elongate stem portion of the seal member includes a locking feature that engages a corresponding locking feature formed on the cover member.

8. The seal assembly of claim 7, wherein the locking feature of one of the cover member and stem portion comprises a protruding boss, and the locking feature of the other of the cover member and the elongate stem portion of the seal member comprises an indentation sized to receive the protruding boss therein.

9. The seal assembly of claim 2, wherein one of the elongate stem portion of the seal member and the cover member further includes a locating feature sized to engage a complimentary surface formed on the other of the cover member or the elongate stem portion of the seal member, the locating feature and complementary surface positioned so that, when engaged, the axially mating portions of the seal assembly are mated in predefined radial orientation relative to each other.

10. The seal assembly of claim 1, wherein the sealing face is provided with one or more lubricating grooves dimensioned to permit a fluid to enter a sealing interface defined between the sealing face and an opposing surface of the downstream member.

11. The seal assembly of claim 10, wherein the sealing face is further provided with one or more feed channels for communicating a fluid from the fluid passageway to one or more of the one or more lubricating grooves.

12. The seal assembly of claim 10, wherein the one or more grooves comprise a plurality of discrete grooves partially surrounding the opening through the cover member.

13. The seal assembly of claim 12, wherein the sealing face is further provided with one or more feed channels for communicating a fluid from the fluid passageway to one or more of the plurality of discrete grooves.

14. The seal assembly of 10, wherein the one or more grooves comprise a continuous circular groove surrounding the opening through the cover member.

15. The seal assembly of claim 14, wherein the sealing face is further provided with one or more feed channels for communicating a fluid from the fluid passageway to the continuous circular groove.

16. The seal assembly of claim 1, wherein the radially-extending flange is an annular flange of convex cross-section extending radially away from a central axis of the seal assembly defined coaxially with a longitudinal axis of the fluid passageway.

17. The seal member of claim 16, wherein the radially-extending flange is further characterized by a tapered thickness proceeding radially outwardly from the said central axis to a peripheral edge of the flange.
